(19) United States
(12) Patent Application Publication
(10) Pub. No.: US 2004/0001934 A1
(43) Pub. Date: Jan. 1, 2004

(54) Recyclable carpet products and method of making

(75) Inventor: Dennis C. Young, Mechanicsburg, PA (US)

Correspondence Address: WOOD, HERRON & EVANS, LLP, 2700 CAREW TOWER, 441 VINE STREET, CINCINNATI, OH, 45202, US

(73) Assignee: Lear Corporation, Southfield, MI

(21) Appl. No.: 10/183,357

(22) Filed: Jun. 28, 2002

(51) Int. Cl. B32B 33/00; B32B 3/02

(52) U.S. Cl. 428/95; 428/97; 428/96; 156/72

(57) ABSTRACT

Recyclable carpet products are made by incorporating a reactive compatibilizing agent in the precoat layer which is used to bond a polymeric face fiber layer to a backing polymeric layer where the polymers of the respective layers are otherwise incompatible to make homogeneous recycled blends.

### TECHNICAL FIELD OF THE INVENTION

This invention relates to recyclable carpet products and a method for making such products.

### BACKGROUND OF THE INVENTION

Plastics are now used in every segment of American business and are found in all aspects of daily life. Carpets are now substantially made of plastics. One problem relating to carpets is what to do with them after their service life is exhausted. Furthermore, since a considerable amount of waste is involved in the process of making carpets, the problem also exists of what to do with it once it is generated. For instance, automobile carpet in most instances has a face of fiber forming polymer such as polyamide and/or a polyester and a backing polymer such as a polyolefin or copolymer thereof. Automotive carpet scrap is generated during the cars' fitting process and as post-consumer waste. During the fitting process, a quantity of carpet remnant is generated as the carpet is formed and cut into various irregular shapes. As a result, millions of pounds of carpet waste are generated every year as part of the automobile manufacturing process. It has been difficult to reuse this carpet scrap in the primary manufacturing process, due to problems with separation, and the like. Furthermore, when an automobile is disposed of after its years of useful life, the carpet installed ends up in the waste stream as post-consumer waste.

Besides the carpet waste generated by automobile manufacturing, carpet waste is also generated during residential and non-residential building construction as well as during renovation. The volume of this carpet scrap generated each year is expected to continue to increase worldwide. Considerable effort has been devoted to recycling carpet waste. Furthermore, the interest in secondary recycling of carpet or other commingled waste continues to increase due to increasing costs of storage and/or land fill space, more stringent regulations for disposal, and incineration, among other things.

A number of methods have been developed for the recycling of carpet scrap. For example, U.S. Pat. Nos. 5,719,198; 5,852,115; and 5,859,071 disclose the addition of compatibilizing agents to mixtures of carpet scrap. In particular, carpet scrap mixtures of nylon, polyester, polypropylene, polyethylene, ethylene vinyl acetate (EVA), and filler, were compatibilized with a polypropylene having acrylic acid grafted thereon, a maleic anhydride modified poly(ethylene-co-vinyl acetate), and a poly(ethylene-co-vinyl acetate). Substantially homogeneous thermoplastic blends of the carpet scrap and these compatibilizing agents have produced products possessing very useful properties, for instance, tensile strengths, elongations at break, and hardness. Further improvements have been made employing ultra low density polyethylene (ULDPE) as disclosed in U.S. Pat. No. 6,241,168. According to this patent, ULDPE is added as a compatibilizing agent to a heterogeneous mixture of polyamides and/or polyesters in combination with polyolefins or copolymers thereof for compatibilization of the polymers. Upon heating the granulated scrap and admixture with the compatibilizing agent, substantially homogeneous thermoplastic blends are produced.

Notwithstanding the improvements that have been made in the art of recycling carpet, further improvements are sought.

### SUMMARY OF THE INVENTION

This invention is directed to recyclable carpet products and methods of making them. In particular, recyclable carpet products are made having a layer of polymeric face fibers and a polymeric backing layer for the face fibers where the face layer and polymeric backing contain incompatible polymers. An intermediate bonding layer is provided between the face fibers and the polymeric backing to bind the fibers to the backing. The intermediate bonding layer contains a reactive compatibilizing agent for reaction with and compatibilization of the incompatible polymers in the face and backing layers upon recycling the carpet product by granulating and heating to form a substantially homogeneous polymer blend.

A method for making a recyclable carpet product is also provided by applying a precoat layer between the face fibers layer and the polymeric backing layer wherein the precoat layer contains a reactive compatibilizing agent. The reactive compatibilizing agent in the precoat performs a dual function of binding the fibers at the interface of the face layer and the backing layer during the formation of the composite and remaining inherently reactive for compatibilizing the otherwise incompatible polymers in the face and backing layers thereby enabling the recyclability of the carpet product to make a homogeneous blend. This invention also eliminates the need for post addition of a compatibilizing agent upon recycling of a carpet product.

A number of advantages are achieved by incorporating the reactive compatibilizing agent in the precoat of the recyclable carpet product. For instance, very significant improvements in properties, such as tensile and elongation, are achieved in the recycled blends. Furthermore, as indicated above, this invention eliminates the need for post addition of compatibilizing agents in carpet scrap for recycling. Reactive compatibilizers for this invention have the dual function of binding the fibers of the face layer during the formation of the composite to the backing layer, yet they remain reactive with the otherwise incompatible polymers of the respective layers thereby enabling the carpet product to be recyclable by granulating and heating to form a substantially homogeneous polymer blend. Thus, the addition of a compatibilizing agent to the granulated product is avoidable.

The advantages and objectives of this invention will be further understood with reference to the following detailed description and operating examples.

### DETAILED DESCRIPTION OF THE INVENTION

A. Carpet Products

In general, carpet products comprise face fibers and a backing layer. Synthetic carpet face fibers may comprise polyamides and/or polyesters, typically nylon. Nylon 6 or nylon 6.6 polymers are usually used. However, polypropylene, polyethylene, other polyesters such as polyethylene terephthalate (PET), may be employed. A primary backing layer such as polyolefin or polypropylene, a precoat layer of unfilled EVA or low density polyethylene, and a mass back of ethylene vinyl acetate (EVA) may be typically provided as in an automotive carpet. More specifically, the back coating contains a filler such as barium sulfate or calcium carbonate with a polymer matrix of EVA containing processing oils. These compositions are well known and comprise a typical North American carpet product for automotive purposes. Typical carpet products and carpet scrap compositions are disclosed in U.S. Pat. Nos. 5,852,115; 5,719,198; 5,859,071; and 6,241,168, and their disclosures are incorporated herein by reference.

Carpet products may be divided into two major categories, i.e., woven and nonwoven carpets. Nonwoven bonded carpets are sometimes also called “composites.” They consist of fiber mats held together because of their inherent bonding properties or as a result of a mechanical process involving the use of a chemical bonding agent.

Tufted carpets are composite structures in which the fibers that form the pile (the surface of the carpet), typically nylon 6 or nylon 6.6 polypropylene, or polyester, as set forth in further detail below, are needled through a backing fabric or layer such as a spun bonded polyester. The base of each fiber extends through the backing and is visible on the bottom surface of the composite structure. Tufted carpets are generally of two types, nap and shag. In nap carpets, fiber loops are formed by needling or punching a continuous fiber just through the base fabric, thus forming the base of the carpet, while the tops of the loops are generally ¼ to ¾ inch long, thus forming the wearing surface of the carpet. Shag carpets have the same base as the nap carpet but the tops of the loops have been split or the tips of the loops have been cut off. The surface of the shag carpet is thus formed by the open ends of the numerous U-shaped pieces of fibers, the base of the U being embedded in the base fabric or backing.

Where the loops of fibers are needled through and embedded in the backing (the combination of which is the raw tufted carpet), they must be secured to the base fabric or backing to prevent the loops of fibers from being pulled out of the backing. The tufted fibers are secured by applying a coating composition known as a precoat to the back of the raw tufted fibers to bond the tufted yarns to the base fabric or backing. In this invention, the precoat consists essentially of a reactive compatibilizing agent for the otherwise incompatible polymers of the face fibers and backing. A secondary backing material, known usually as a mass coat, may also applied to the back of the raw tufted carpet and bonded to it with the same precoat composition that secures the fibers to the base fabric or backing.

The mass coat can be heavily filled or unfilled polyethylene or ethylene-vinyl acetate copolymer. The application of the secondary backing material further secures the loops of fibers since they are then bonded by the precoat adhesively to the backing material as well as the base fabric. The base fabric or primary backing may be of any type known in the art and may be nonwoven polymer fabric. Likewise, the secondary backing material may be a woven polymer fabric. The aforementioned backings are formed from materials such as needle-punched, woven or nonwoven polypropylene and nonwoven polyester webs and fabrics and blends thereof.

Automotive carpets differ slightly from other carpets. The principal difference is the amount of back coat material used. The polymeric back coat or mass coat in automotive carpets serves an additional purpose beyond securing tufts in place and consolidating the carpet's foundation. It serves as a sound insulation barrier in an automobile. The quiet ride effect is achieved, in part, using the carpet's back coat. Increasing the mass between a noise source and the interior of the automobile is a typical way to obtain a “quiet ride.” Thus, the automotive carpet back coatings are generally thick and represent over 50% of the carpet's total weight. Inorganic fillers such as CaCo₃ and BaSo₄ are typically used to improve the sound insulating properties.

B. Recyclable Carpet Products

The recyclable carpet products of this invention are characterized by a layer of polymeric face fibers and a polymeric backing layer for the polymeric face fibers. The polymers of the face fibers and the backing layers are of the type described above where the copolymers are incompatible with one another. For instance, a polyamide and/or polyester face fiber is immiscible with a polyolefin backing. An intermediate bonding layer is provided between the incompatible polymeric face fibers and the polymeric backing layer to bind the fibers to the backing. According to this invention, the intermediate bonding layer consists essentially of a reactive compatibilizing agent for a compatibilization of the incompatible polymers upon recycling the carpet product by granulating and heating to form a substantially homogeneous polymer blend. It is essential that the compatibilizing agent has the properties of adhesiveness during carpet formation to bind the face fibers to the backing layer and a remaining reactivity to enable the incompatible polymers to be recycled into a homogeneous mass.

An automotive carpet composition usually has the following general component ranges:

| Carpet Component | Ranges (% by weight) |
|---|---|
| Polyamide (nylon) | about 10-35 |
| Polyester (polyethylene terephthalate) | about 1-6 |
| Polyolefins (polyethylene and polypropylene) | about 8-18 |
| Copolymers of metallocenes or ethylene | |
| vinyl acetate (EVA) | about 15-36 |
| Filler | about 35-60 |

Reactive compatibilizing agents suitable for use for homogenization of the incompatible polymers of the face and backing layers are selected from a group of agents such as polypropylene having acrylic acid grafted thereon, maleic anhydride modified polypropylene, maleic anhydride modified poly(ethylene-co-vinyl acetate), and a poly(ethylene-co-vinyl acetate). A number of available compatibilizing agents are listed in the following TABLE 1:

TABLE 1

| Tradename | General Material |
|---|---|
| DEFA-1373 NT ™ | Anhydride modified ultralow |
| | density polyethylene (ULDPE) |
| Bynel 302 ™ | Anhydride modified |
| | polypropylene (PP) |
| Bynel 361W ™ | Anhydride modified ethylene |
| | vinyl acetate (EVA) |
| MB226D ™ | Anhydride modified linear low |
| | density polyethylene (LLDPE) |
| Polybond 1001 ™ | Acrylic acid modified |
| | polypropylene (PP) |
| Polybond 1009 ™ | Acrylic acid modified high |
| | density polyethylene (HDPE) |

In a preferred form of the invention, the compatibilizing agent is an anhydride modified EVA polymer. This is exemplified by Bynel 361™ which is a maleic anhydride modified poly(ethylene-co-vinyl acetate). However, other reactive compatibilizing agents in amounts of about 1 to 10% by weight of the carpet may be employed in accordance with the principles of this invention such as those described above. The important feature of the invention is to incorporate the reactive compatibilizing agent in the intermediate bonding layer between the polymeric face fibers and the polymeric backing during carpet manufacture so that it may perform the dual functions of binding the fibers in the manufacture of the product and to facilitate recycling of the carpet by granulating and heating to form a substantially homogeneous polymer blend. These dual functions are performed because the carpet product is made by a process wherein the compatibilizing agent is added as an intermediate bonding layer during the manufacture of the product and, due to temperature processing conditions, the reactivity of the compatibilizing agent is maintained so that it may be reactive with both of the incompatible polymers that are in the face layers and backing layers of the carpet product upon recycling to form a substantially homogeneous polymer blend. For example, when using an anhydride modified EVA, the temperature of application of the precoat between the nylon face fibers and the PET backing is about 180° to about 205° C. so that its reactivity is maintained for recyling the carpet. It has been found upon recycling at temperatures of at least about 230° C. and more preferably about 250° C. that the anhydride modified EVA is activated for reactivity with the different polymers in the face fibers and backing layers. Of course as a person of skill would understand, these temperatures of carpet manufacture for bonding and recycling will vary depending upon the composition of the carpet and reactivity of the compatibilitizing agent.

C. The Method of Making a Recyclable Carpet Product

The preferred method of making the recyclable carpet products of this invention involves the steps of providing a face layer of fibers such as those described above, typically, of the woven or nonwoven type. A base layer for the face layer is provided comprising a polymer which is incompatible with the polymer of the face layer. A precoat layer is applied between the face layer and the backing layer to secure the fibers of the face layer to the backing layer. In the precoat layer, there is contained a reactive compatibilizing agent such as an anhydride modified polyolefin which has the distinct chemical functionalities of bonding the fibers of the face layer to the base layer and residual reactivity with the different polymers whereby the carpet product is recyclable by granulating and heating the product to form a substantially homogeneous polymer blend without the addition of a compatibilizing agent to the granulated product.

The invention will be further understood with reference to the following examples.

### EXAMPLES

A typical tufted automotive carpet composite of this invention is made up of five layers as illustrated by the following:

| | Layer | Components (Percent by Weight) | |
|---|---|---|---|
| 1 | Carpet Face | polyamide such as nylon | about |
| | | | 10-35% |
| 2 | Primary Backing | polyesters such as spun bonded | about |
| | | | 1-6% |
| | | polyethylene terephthalate (PET) | |
| 3 | Precoat | anhydride modified EVA | about |
| | | | 8-18% |
| 4 | Masscoat | filled EVA or EPDM | about |
| | | | 48-65% |
| 5 | Secondary Backing | spun bonded PET | about |
| | | | 0.6-1% |

The nylon fibers are needled through the PET primary backing to form a raw tufted carpet base which is then secured to prevent the loops from being pulled out of the PET base fabric. In this example, the anhydride modified EVA is applied as a precoat to the back of the raw tufted carpet to bond the tufted nylon to the PET backing.

The precoat is applied at a temperature of about 205° C. A secondary backing known as the mass coat is also applied to the back of the raw tufted carpet and bonded to it with the same precoat that secures the nylon to the base fabric. As described above, the mass coat can be heavily filled or unfilled and it further secures the nylon loops since they are bonded by the adhesive to the backing material as well as to the base fabric. The temperatures of applying a mass coat or a further secondary backing are on the order of about 180° C. to about 215° C. The anhydride modified EVA must be applied under processing temperature conditions so that it serves a useful function of bonding the precoat to the back of the raw tufted carpet and remaining reactive for subsequent compounding of the recyclable carpet product during recycling.

Samples of recyclable carpet are melted and compounded with pelletalization at temperatures of at least about 230° C. to about 250° C., using a twin screw extruder. Pellets are injection molded into standard ASTM test specimens. Tensile and impact properties as well as shore hardness were determined under ASTM protocols.

To further illustrate the principles of this invention, two composites of TABLE 2 were made employing layers 1-3 like that described above, except in the first instance standard low density polyethylene LDPE (Standard) precoat was employed to bond the nylon to PET in a comparative example and an anhydride modified EVA precoat (Bynel E-361™) was employed as a reactive compatibilizer in a second example (Invention). Once the fibers of the carpet face were precoated and bonded to the PET primary backing, each composite was checked for fiber characteristics. The temperature employed for bonding with LLPE or Bynel E-361™ is 205° C.

TABLE 2

| | Composite | | | |
|---|---|---|---|---|
| | Standard | | Invention | |
| Carpet face | 14 | oz. | 14 | oz. |
| Primary backing | 6 | oz. | 6 | oz. |
| Precoat | 10 | oz. | 10 | oz. |

Also, upon densification of each composite at about 230° C. to 250° C., injection mold samples and ASTM physical test properties were performed on each and the results are provided in the following TABLE 3.

TABLE 3

| | Standard | Invention |
|---|---|---|
| Fiber Properties | | |
| Tuft Bind (Original) | 18.8* | 18.0* |
| Tuft Bind (Cycled) | 17.0* | 21.6* |
| Fiber Loss | 0.35 | .20 |
| Taber Abrasion | SAT** | SAT** |
| ASTM Tests | | |
| Tensile (MPa) | 8.9 | 12.9 |
| Elongation (%) | 3.5 | 500 |

*newtons
**satisfactory

With reference to the above TABLE 3, the fiber binding properties are basically equivalent for the two composites, i.e., the Standard and Invention. Either system could be used to produce a functional automotive full floor carpet. However, when one observes the ASTM 412 testing for the densified system (which is used as a guide for recyclability), a tremendous difference has been found in toughness of the two materials, indicated by the tensile/elongation properties. When the reactive compatibilizing agent is added to the precoat, the recyclable product is over 100 times more extensible than the LDPE precoated sample. Whereas the Standard sample is very stiff and brittle, the Invention sample is very flexible.

Furthermore, if the above data were compared to a sample of carpet scrap having a polyethylene precoat layer wherein the Bynel 361™ was added as a post addition compatibilizer in the same amount, it has been found that the above Invention sample had approximately 10 times the extensibility of the recyclable product containing the post addition of Bynel 361™. This is very surprising allowing for the fact that both the Invention and the polyethylene precoat composites had the same concentration of Bynel 361™.

Other benefits and advantages of this invention will be further apparent to a person of ordinary skill in the art with reference to the above detailed description and experimental results, and such modifications are within the scope of this invention.

What is claimed is:

1. A recyclable carpet product comprising
a layer of polymeric face fibers and a polymeric backing layer for said polymeric face fibers, said face layer and polymeric baking layer containing normally incompatible polymers, and
an intermediate bonding layer between said polymeric face fibers and said polymeric backing layer to bind the fibers to the backing, said intermediate bonding layer containing a reactive compatibilizing agent for compatibilization of the incompatible polymers upon recycling the carpet product by granulating and heating to form a substantially homogeneous polymer blend.

2. The recyclable carpet product of claim 1 wherein said incompatible polymers are selected from the group consisting of a polyamide, polyester and polyolefin, and mixtures thereof.

3. The recyclable carpet product of claim 1 wherein the composition of the polymeric face layer and polymeric backing layer comprises the following components in percent by weight:
about 10 to about 35 polyamide;
about 1 to about 6 polyester;
about 8 to about 18 polyolefin;
about 15 to about 36 metallocene or ethylene vinyl acetate copolymer; and
about 35 to about 60 filler.

4. The recyclable carpet product of claim 3 wherein said polyamide is a nylon, said polyester is a polyethylene terephthalate, and said polyolefin is selected from the group consisting of polyethylene and polypropylene.

5. The recyclable carpet product of claim 2 wherein the reactive compatibilizing agent is a modified polyolefin selected from the group consisting an anhydride modified polyolefin and an acrylic acid modified polyolefin.

6. The recyclable carpet product of claim 5 wherein the anhydride modified polyolefin is selected from the group consisting of an anhydride modified ultralow density polyethylene, an anhydride modified polypropylene, an anhydride modified linear low density polyethylene, and an anhydride modified ethylene vinyl acetate.

7. The recyclable carpet product of claim 5 wherein said acrylic acid modified polyolefin is selected from the group consisting of acrylic acid modified polypropylene and acrylic acid modified high density polyethylene.

8. The recyclable carpet product of claim 5 wherein said modified polyolefin is contained in an amount from about 1% to about 10% by weight of said carpet.

9. A method of making a recyclable carpet product comprising
providing a layer of polymeric face fibers and a polymeric backing layer for said polymeric face fibers, wherein said face and polymeric backing layer contain incompatible polymers,
attaching said polymeric face fibers to said polymeric backing layer, and
applying an intermediate bonding layer between said polymeric face fibers and said polymeric backing layer to bind the fibers to the backing, said intermediate bonding layer containing a reactive compatibilizing agent for compatibilization of the incompatible polymers upon recycling the carpet product by granulating and heating to form a substantially homogeneous polymer blend.

10. The method of claim 9 wherein said reactive compatibilizing agent is a thermoplastic composition containing a reactive compatibilizing agent for application at a temperature sufficient to achieve bonding of the polymeric face fibers to said polymeric backing layer and for compatibilization of said incompatibile polymers upon recycling to form a substantially homogeneous polymer blend.

11. The method of claim 9 wherein said incompatible polymers are selected from the group consisting of a polyamide, polyester and polyolefin, and mixtures thereof.

12. The method of claim 9 wherein the composition of the face layer and polymeric backing layer comprises the following components in percent by weight:
about 10 to about 35 polyamide;
about 1 to about 6 polyester;
about 8 to about 18 polyolefin;
about 15 to about 36 metallocene or ethylene vinyl acetate copolymer; and
about 35 to about 60 filler.

13. The method of claim 12 wherein said polyamide is a nylon, said polyester is a polyethylene terephthalate, and said polyolefin is selected from the group consisting of polyethylene and polypropylene.

14. The method of claim 12 wherein the reactive compatibilizing agent is a modified polyolefin selected from the group consisting an anhydride modified polyolefin and an acrylic acid modified polyolefin.

15 The method of claim 14 wherein the anhydride modified polyolefin is selected from the group consisting of an anhydride modified ultralow density polyethylene, an anhydride modified polypropylene, an anhydride modified linear low density polyethylene, and an anhydride modified ethylene vinyl acetate.

16. The method of claim 14 wherein said acrylic acid modified polyolefin is selected from the group consisting of acrylic acid modified polypropylene and acrylic acid modified high density polyethylene.

17. The method of claim 14 wherein said modified polyolefin is contained in an amount from bout 1% to about 10% by weight of said carpet.

18. The method of claim 12 wherein the bonding temperature is about 180° C. to about 205° C. and the compatibilization temperature is at least about 230° C. to activate the compatibilizing agent.

19. A recyclable carpet product comprising:
a face layer comprising a first polymer and having first and second sides,
a base fabric layer comprising a second polymer different than the first polymer and having a first side adjacent the second side of the face layer, wherein fibers of the first polymer are attached through the base fabric layer to be exposed on the first side of the face layer and on a second side of the base fabric layer, and wherein the first and second polymers are immiscible with each other, and
a precoat layer on the second side of the base fabric layer to secure the fibers of the first polymer to the base fabric layer, wherein the precoat layer comprises a reactive compatibilizing polymer having two distinct chemical functionalities, one of said functionalities being reactive with the first polymer and the other of said functionalities being reactive with the second polymer,
whereby said carpet product is recyclable by granulating and heating the product to form a substantially homogeneous polymer blend without the addition of a compatibilizing agent to the granulated product.

20. The recyclable carpet product of claim 19, further comprising a back coat layer of a filled thermoplastic secured to the precoat layer.

21. The recyclable carpet product of claim 20, further comprising a second base fabric layer secured to the back coat layer.

22. A method of making a recyclable carpet product comprising
providing a face layer of fibers comprising a first polymer and having first and second sides,
providing a base fabric layer of fibers comprising a second polymer different than the first polymer and having a first side adjacent the second side of the face layer of fibers, wherein the first and second polymers are immiscible with each other,
attaching said face fibers of the first polymer through the base fabric layer for exposure on the first side of the face layer and on a second side of the base fabric layer; and
applying a precoat layer on the second side of the base fabric layer at a bonding temperature to secure the fibers of the first polymer to the base fabric layer, wherein the precoat layer comprises a reactive compatibilizing polymer having two distinct chemical functionalities at a reactivity temperature, one of said functionalities being reactive with the first polymer and the other of said functionalities being reactive with the second polymer,
whereby said carpet product is recyclable by granulating and heating the product to form a substantially homogeneous polymer blend without the addition of a compatibilizing agent to the granulated product.

23. The method of claim 22, further comprising securing a back coat layer of titled thermoplastic to the precoat layer.

24. The method of claim 22, further comprising securing a second base fabric layer to the back coat layer.

25. The method of claim 22 wherein said incompatible polymers are selected from the group consisting of a polyamide, polyester and polyolefin, and mixtures thereof.

26. The method of claim 22 wherein the composition of the face layer and polymeric backing layer comprises the following components in percent by weight:
about 10 to about 35 polyamide;
about 1 to about 6 polyester;
about 8 to about 18 polyolefin;
about 15 to about 36 metallocene or ethylene vinyl acetate copolymer; and
about 35 to about 60 filler.

27. The method of claim 25 wherein said polyamide is a nylon, said polyester is a polyethylene terephthalate, and said polyolefin is selected from the group consisting of polyethylene and polypropylene.

28. The method of claim 26 wherein the reactive compatibilizing agent is a modified polyolefin selected from the group consisting an anhydride modified polyolefin and an acrylic acid modified polyolefin.

29. The method of claim 28 wherein the anhydride modified polyolefin is selected from the group consisting of an anhydride modified ultralow density polyethylene, an anhydride modified polypropylene, an anhydride modified linear low density polyethylene, and an anhydride modified ethylene vinyl acetate.

30. The method of claim 28 wherein said acrylic acid modified polyolefin is selected from the group consisting of acrylic acid modified polypropylene and acrylic acid modified high density polyethylene.

31. The method of claim 28 wherein said modified polyolefin is contained in an amount from bout 1% to about 10% by weight of said carpet.

32. The method of claim 28 wherein the bonding temperature is about 180° C. to about 205° C. and the reactivity temperature is at least about 230° C. to activate the compatibilizing polymer.
